(19) United States
(12) Patent Application Publication
(10) Pub. No.: US 2025/0363847 A1
(43) Pub. Date: Nov. 27, 2025

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Masahiko OSAKA, Tokyo (JP)

(73) Assignee: NEC Corporation, Tokyo (JP)

(21) Appl. No.: 19/211,552

(22) Filed: May 19, 2025

(30) Foreign Application Priority Data
May 24, 2024 (JP) 2024-084654

(51) Int. Cl. G07C 9/37

(52) U.S. Cl. CPC G07C 9/37

(57) ABSTRACT

An information processing apparatus according to an example aspect includes: at least one memory configured to store instructions; and at least one processor configured to execute the instructions to: track a first target and a second target included in a first group; and control to restrict the first target and the second target from entering a predetermined area in case an authentication of the first target is unsuccessful.

### INCORPORATION BY REFERENCE

This application is based upon and claims the benefit of priority from Japanese Patent Application No. 2024-084654, filed on May 24, 2024, the disclosure of which is incorporated herein in its entirety by reference.

### TECHNICAL FIELD

This disclosure relates to the technical fields of information processing apparatus, information processing methods, and recording media.

### BACKGROUND ART

Apparatus that authenticates using images is known. For example, International Publication No. 2023/176167 discloses an apparatus that acquires an image, extracts a face from the acquired image, compares the information of the extracted face with the information of the face registered in the authentication information stored in a storage apparatus, and authenticates by determining whether the extracted face is the face whose information is registered in the authentication information.

### SUMMARY

It is an example object of this disclosure to provide an information processing apparatus, an information processing method, and a recording medium that appropriately assists in authentication a target.

An information processing apparatus according to an example aspect includes: at least one memory configured to store instructions; and at least one processor configured to execute the instructions to: track a first target and a second target included in a first group; and control to restrict the first target and the second target from entering a predetermined area in case an authentication of the first target is unsuccessful.

An information processing method according to an example aspect includes: tracking a first target and a second target included in a first group; and controlling to restrict the first target and the second target from entering a predetermined area in case of an authentication of the first target is unsuccessful.

A recording medium according to an example aspect is a recording medium on which a computer program that allows a computer to execute an information processing method is recorded, the information processing method including: tracking a first target and a second target included in a first group; and controlling to restrict the first target and the second target from entering a predetermined area in case of an authentication of the first target is unsuccessful.

### BRIEF DESCRIPTION OF THE DRAWINGS

FIG. 1 is a block diagram illustrating an example of a configuration of an information processing apparatus according to this disclosure;

FIG. 2 is a flowchart illustrating an example of a flow of operation of the information processing apparatus according to this disclosure;

FIG. 3 is an overview of an information processing system according to this disclosure;

FIG. 4 is a block diagram illustrating an example of a configuration of the information processing apparatus according to this disclosure;

FIG. 5 is a flowchart illustrating an example of a flow of operation of the information processing apparatus according to this disclosure;

FIG. 6A and FIG. 6B are schematic diagrams showing an overview of an information processing operation in the information processing apparatus according to this disclosure;

FIG. 7A and FIG. 7B are schematic diagrams showing an overview of an information processing operation in the information processing apparatus according to this disclosure;

FIG. 8 is a block diagram illustrating an example of a configuration of an information processing system according to this disclosure;

FIG. 9 is a schematic diagram showing an overview of an information processing operation in the information processing system according to this disclosure;

FIG. 10 is a schematic diagram showing an overview of an information processing operation in the information processing system according to this disclosure;

FIG. 11 is a schematic diagram showing an overview of an information processing operation in the information processing system according to this disclosure;

FIG. 12 is a schematic diagram showing an overview of an information processing operation in the information processing system according to this disclosure;

FIG. 13 is a block diagram illustrating an example of a configuration of an information processing system according to this disclosure;

FIG. 14 is a schematic diagram showing an overview of an information processing operation in the information processing system according to this disclosure;

FIG. 15 is a block diagram illustrating an example of a configuration of an information processing system according to this disclosure;

FIG. 16 is a block diagram illustrating an example of a configuration of an information processing system according to this disclosure;

FIG. 17 is a flowchart illustrating an example of a flow of operation of the information processing system according to this disclosure;

### EXAMPLE EMBODIMENTS

The following describes the embodiments of the information processing apparatus, the information processing system, the information processing method, and the recording medium, with reference to the drawings.

### 1: First Example Embodiment

The first embodiment of the information processing apparatus, the information processing system, the information processing method, and the recording medium is described below. The following describes the first embodiment of the information processing apparatus, the information processing system, the information processing method, and the recording medium, using an information processing apparatus 1 according to this disclosure.

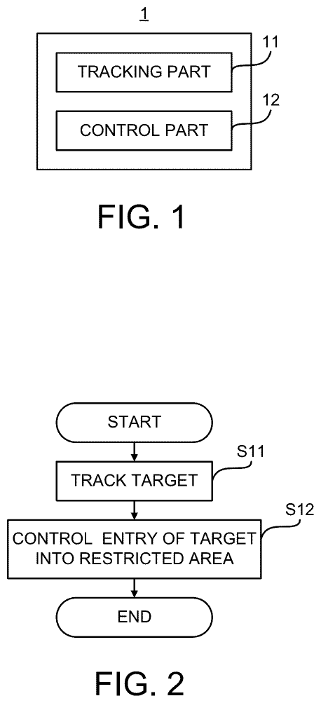

Referring to FIG. 1 and FIG. 2, this disclosure will be explained. As shown in FIG. 1, the information processing apparatus 1 includes a tracking part 11 and a control part 12. The operation of the information processing apparatus 1 will be explained with reference to the flowchart in FIG. 2.

As shown in FIG. 2, the tracking part 11 tracks a target (step S11). “Target” is a target of authentication. The tracking part 11 may track a first target and a second target. The first target and the second target are included in a first group. In this embodiment, for example, persons who share the same behavior may be included in the same group as target. Information indicating that the first target and the second target are included in the first group may be registered in advance. The tracking part 11 may have acquired information indicating that the first target and the second target are included in the first group before the operation in step S11. The tracking part 11 tracks the first target while recognizing that the first target is a target included in the first group. The tracking part 11 also tracks the second target while recognizing that the second target is a target included in the first group.

The control part 12 controls the entry of target into a predetermined area (step S12). The predetermined area may be an area where the entry of a target that has unsuccessfully authenticated is restricted. Hereafter, an area where an entry of a target that has unsuccessfully authenticated is restricted is referred to as “restricted area.” The restricted area may be an area where the entry of one or more target is restricted in case there are two people, the first target and the second target. In case the first target has unsuccessfully authenticated, the control part 12 may control to restrict the entry of the first target into the restricted area. As mentioned above, the first target and the second target are included in the first group. In this case, the control part 12 controls access to the predetermined area for the first target, for which authentication has unsuccessful, and the second target, who is in the same group as the first target.

In this way, the information processing apparatus 1 performs an information processing method that tracks the first target and the second target, which are included in the first group, and controls access to the predetermined area for the first target and the second target in case the first target has unsuccessfully authenticated.

The information processing apparatus 1 described above may be achieved by having a computer read a computer program recorded on a recording medium. In this case, the computer program may cause the computer to execute an information processing method that controls the first target and the second target included in the first group so that, in case the first target has unsuccessfully authenticated, the first target and the second target are restricted from entering the predetermined area.

### Technical Effect

The information processing apparatus 1 according to this disclosure can prevent the persons included in the group from losing sight of each other and being unable to act together by controlling not only the target that had unsuccessfully authenticated, but also restricting the movement of other target in the group.

### 2: Second Example Embodiment

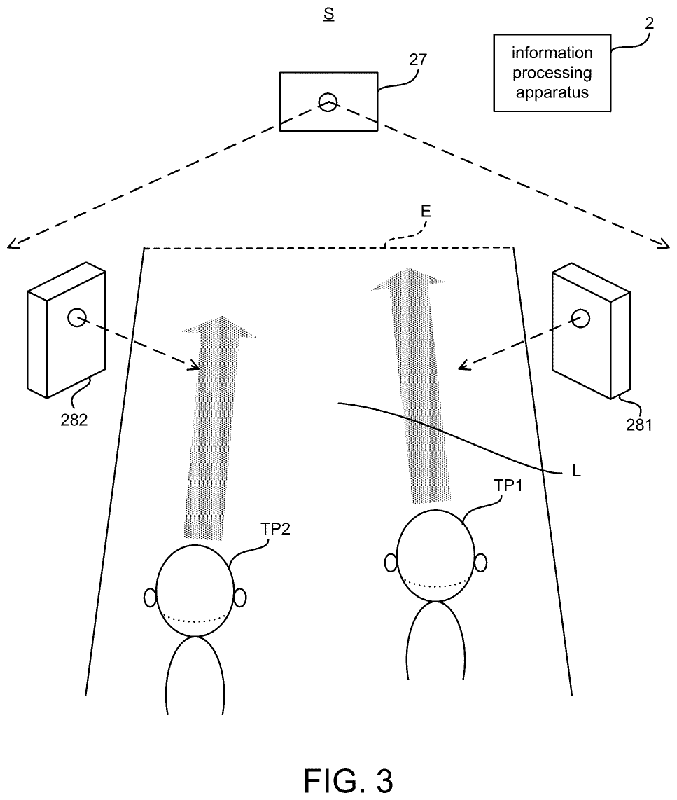

The second embodiment of the information processing apparatus, the information processing system, the information processing method and the recording medium is explained with reference to FIG. 3 to FIG. 7. In the following, the second embodiment of the information processing apparatus, the information processing system, the information processing method, and the recording medium is described using an information processing system S. For the second embodiment, explanations that overlap with the above-mentioned first embodiment are omitted as appropriate.

### 2-1: Configuration of the Information Processing System S

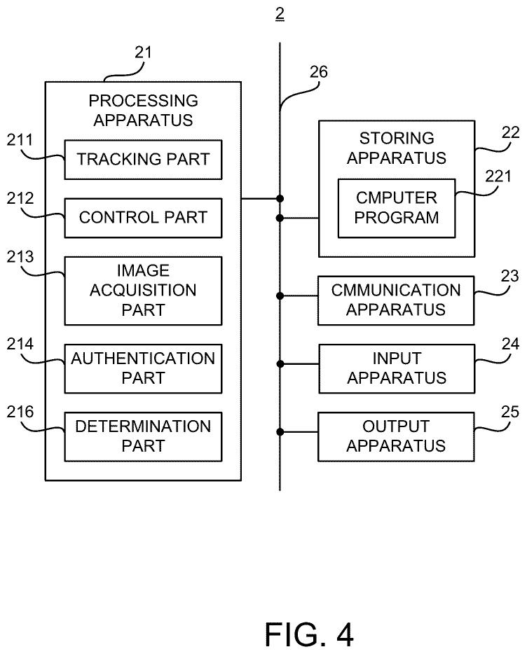

FIG. 3 is an overview diagram showing an overview of the information processing system S of this disclosure. FIG. 4 is a block diagram showing the configuration of an information processing apparatus 2 according to this disclosure.

As shown in FIG. 3, the information processing system S is applied to a location where a first target TP1 and a second target TP2 can move side by side. This location where the first target TP1 and the second target TP2 can move side by side is referred to as a lane L. The destinations of the first target TP1 and the second target TP2 may be at the ends of the arrow directions illustrated in FIG. 3 as an example. The first target TP1 and the second target TP2 may be guided to move in the direction of the arrow shown in FIG. 3. The first target TP1 and the second target TP2 move in a longitudinal direction of the lane L. The direction in which the first target TP1 and the second target TP2 move may be referred to as “moving direction.” In the lane L, the first target TP1 and the second target TP2 may move side by side in a direction other than the moving direction. In the lane L, the first target TP1 and the second target TP2 may be able to move side by side in a lateral direction of the lane L (referred to as “a width direction of the lane L”). The width direction of the lane L may be about twice the width of a passageway that an average adult can move through. In other words, the lane L may have a width that allows two targets to move in line in a direction different from the moving direction.

As shown in FIG. 3, the information processing system S may be provided with a camera 27, a first camera 281, a second camera 282, and the information processing apparatus 2. The camera 27 may be a camera capable of imaging light in the visible light wavelength range (so-called visible light camera). Alternatively, the camera 27 may be a camera capable of imaging light in the near-infrared wavelength range (so-called near-infrared camera). In addition, the images captured by the camera 27 may include moving images. The first camera 281 and the second camera 282 may be cameras capable of capturing light in the near-infrared wavelength range (so-called near-infrared cameras). Alternatively, the first camera 281 and the second camera 282 may be cameras capable of capturing light in the visible wavelength range (so-called visible light cameras). In addition, the images captured by the first camera 281 and the second camera 282 may include moving images.

The camera 27 captures an image of a space in which the first target TP1 and the second target TP2 can move side by side. The camera 27 acquires an image including the first target TP1 and the second target TP2 by capturing the image. The camera 27 may capture an image of a space in which the first target TP1 and the second target TP2 can move side by side in the width direction of the lane L. The camera 27 may be provided at a location where it is possible to look down on the first target TP1 and the second target TP2 moving side by side, as shown in FIG. 3. The camera 27 may be provided so as to capture an area where the first target TP1 and the second target TP2 can move side by side. The camera 27 may be provided so as to capture an area where at least one of the first camera 281 and the second camera 282 can be captured.

The first camera 281 may be provided at an one end of a direction different from the moving direction. For example, the first camera 281 may be provided at an one end of a horizontal direction perpendicular to the moving direction. In other words, the first camera 281 may be provided at an one end of the width direction of the lane L. The second camera 282 may be provided at an other end of the direction different from the moving direction. For example, the second camera 282 may be provided at an other end of the horizontal direction perpendicular to the moving direction. In other words, the second camera 282 may be provided at an other end of the width direction of the lane L. It may be said that there is a space in which the first target TP1 and the second target TP2 can move side by side between the first camera 281 and the second camera 282.

The first camera 281 may image an iris of the target moving on one side of the width direction of the lane L from the one side of the width direction of the lane L. In the case of the example in FIG. 3, the first camera 281 may be provided at a right side of the lane L as seen from target (a left side of the lane L as seen from the camera 27). In the case of the example in FIG. 3, the first camera 281 may image an iris of the first target TP1 moving on the right side of the lane L from the right side of the lane L as seen from target.

The second camera 282 may image the iris of the target moving on other side of the width direction of the lane L from the other side of the width direction of the lane L. In the case of the example in FIG. 3, the second camera 282 may be provided at the left side of the lane L as seen from target (the right side of the lane L as seen from the camera 27). In the case of the example in FIG. 3, the second camera 282 may capture an iris of the second target TP2 moving on the left side of the lane L from the left side of the lane L as seen from target.

FIG. 3 shows an example where the camera 27 is provided at a location where it can overlook the first target TP1 and the second target TP2, but the location where the camera 27 is provided is not limited to this. The camera 27 may be provided at the vicinity of at least one of the first camera 281 and the second camera 282. For example, the camera 27 may be provided at the same housing as the first camera 281. In addition, the camera 27 may be provided at the same housing as the second camera 282. The camera 27 may be provided at plural. That is, the camera 27 may be provided at the vicinity of the first camera 281 and the camera 27 may be provided at the vicinity of the second camera 282.

The camera 27 may capture images used to track the target. In addition, the camera 27 may capture images to determine the camera that captures the iris of the target. Furthermore, the camera 27 may capture images to determine the position of the iris of the target.

As shown in FIG. 4, the information processing apparatus 2 is provided with a processing apparatus 21, a storing apparatus 22, a communication apparatus 23, an input apparatus 24 and an output apparatus 25. The processing apparatus 21, the storing apparatus 22, the communication apparatus 23, the input apparatus 24 and the output apparatus 25 may be connected via a data bus 26. The processing apparatus 21 is, for example, a CPU (central processing unit), GPU (Graphics Processing Unit), FPGA (Field Programmable Gate Array), TPU (Tensor Processing Unit), and quantum processor, and may include at least one of these.

The storing apparatus 22 may include at least one of a random access memory (RAM), read-only memory (ROM), hard disk apparatus, optical magnetic disk apparatus, solid state drive (SSD), and optical disk array. In other words, the storing apparatus 22 may include non-temporary storage media. The storing apparatus 22 is capable of storing desired data. For example, the storing apparatus 22 may temporarily store the computer program executed by the processing apparatus 21. The storing apparatus 22 may temporarily store data temporarily used by the processing apparatus 21 in case the processing apparatus 21 is executing a computer program.

The communication apparatus 23 may be able to communicate with apparatus external to the information processing apparatus 2. Furthermore, the communication apparatus 23 may be able to communicate by wired or wireless communication. The information processing apparatus 2 is able to communicate with the camera 27, the first camera 281, and the second camera 282 included in the information processing system S. The information processing apparatus 2 may communicate with the camera 27, the first camera 281, and the second camera 282 via the communication apparatus 23. The information processing apparatus 2, the camera 27, the first camera 281, and the second camera 282 may communicate wirelessly or by wired communication.

The input apparatus 24 is an apparatus that can accept information input to the information processing apparatus 2 from the outside. The input apparatus 24 may include an operating apparatus (e.g., keyboard, mouse, touch panel, etc.) that can be operated by the user of the information processing apparatus 2. The input apparatus 24 may include a recording medium reader that can read information recorded on a recording medium that can be attached to or removed from the information processing apparatus 2, such as a USB (Universal Serial Bus) memory apparatus. In addition, in case information is input to the information processing apparatus 2 via the communication apparatus 23 (in other words, in case the information processing apparatus 2 acquires information via the communication apparatus 23), the communication apparatus 23 may function as an input apparatus.

The output apparatus 25 is an apparatus capable of outputting information to the outside of the information processing apparatus 2. The output apparatus 25 may output visual information such as characters and images, auditory information such as sound, or tactile information such as vibration, as the above-mentioned information. The output apparatus 25 may include, for example, at least one of a display, a speaker, a printer, and a vibration motor. The output apparatus 25 may be able to output information to a removable recording medium, such as a USB memory stick, etc.

In addition, in case the information processing apparatus 2 outputs information via the communication apparatus 23, the communication apparatus 23 may function as an output apparatus.

The processing apparatus 21 in this embodiment includes a tracking part 211, a control part 212, an image acquisition part 213, an authentication part 214, and a determination part 216 as function blocks that are logically realized or processing circuits that are physically realized. “The tracking part 211” and ‘the control part 212’ are components that correspond to ‘the tracking part 11’ and ‘the control part 12’ in the first embodiment described above, respectively.

At least one of the tracking part 211, the control part 212, and the image acquisition part 213 may be realized in a form that mixes logical functional blocks and physical processing circuits (i.e., hardware). In case at least one of the tracking part 211, the control part 212, and the image acquisition part 213 is a functional block, at least one of the tracking part 211, the control part 212, and the image acquisition part 213 may be realized by executing a predetermined computer program.

The processing apparatus 21 may acquire (in other words, read) the above-mentioned predetermined computer program from the storing apparatus 22. The processing apparatus 21 may read the above-mentioned predetermined computer program stored on a computer-readable and non-temporary recording medium using the recording medium reader (not shown) provided by the information processing apparatus 2. The processing apparatus 21 may acquire the above-mentioned predetermined computer program from an apparatus outside the information processing apparatus 2 via the communication apparatus 23 (in other words, it may download or read it). As a recording medium for recording the above-mentioned predetermined computer program executed by the processing apparatus 21, at least one of optical discs, magnetic media, magneto-optical discs, semiconductor memories, and other media capable of storing programs may be used.

The information processing system S may be applied to determining whether or not to allow entry into the restricted area and to controlling entry into the restricted area. The restricted area may be an area that the target that has successfully authenticated can enter. The restricted area may be an area beyond an endpoint E of the lane L in the moving direction, as illustrated in FIG. 3. Therefore, the information processing system S may be configured to authenticate the target within the lane L behind the endpoint E of the lane L in the moving direction. The target may be a target for a biometric authentication (i.e., authentication using biometric information). The information processing system S may be configured to authenticate the target using the biometric authentication.

The biometric information is information related to the physical characteristics of the target. Examples of the biometric information include at least one of the following: a facial image including a face of the target, an iris image including an iris of the target, a fingerprint pattern of the target, a palm print pattern of the target, a pattern of veins in fingers and palms of the target, voice information including a voice of the target, and sound information including an acoustic radiation from ear of the target. Examples of the authentication using the biometric information include at least one of a face authentication, an iris authentication, a fingerprint authentication, a handprint authentication, a vein authentication, a voiceprint authentication, and an ear acoustic authentication. The target may be authenticated using one type of biometric information. The target may also be authenticated using a combination of multiple type of biometric information. In other words, the target may be a target for a multi-modal biometric authentication.

### 2-2: Information Processing Method Executed by the Information Processing Apparatus 2

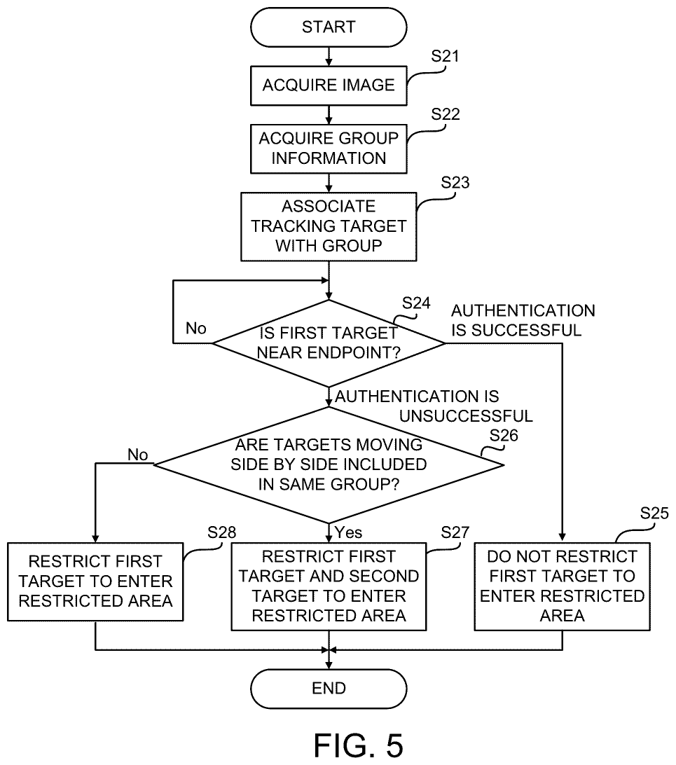

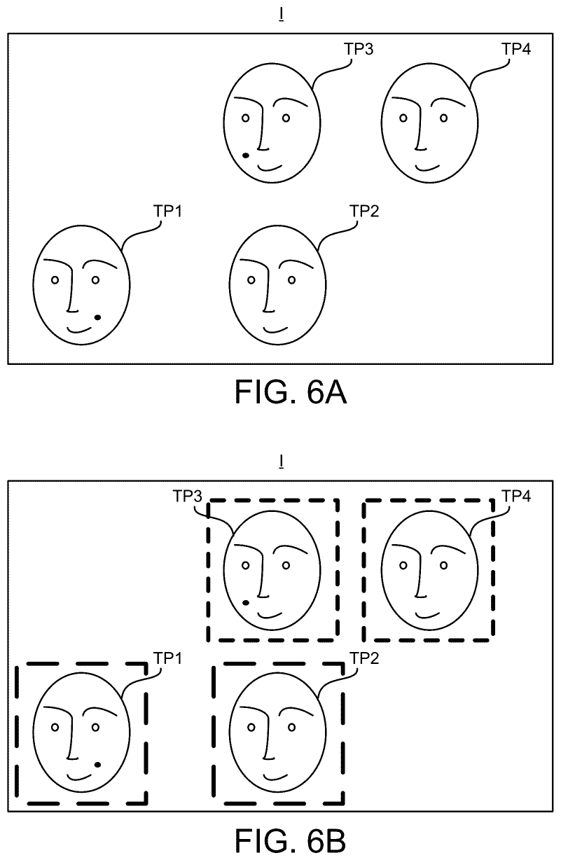

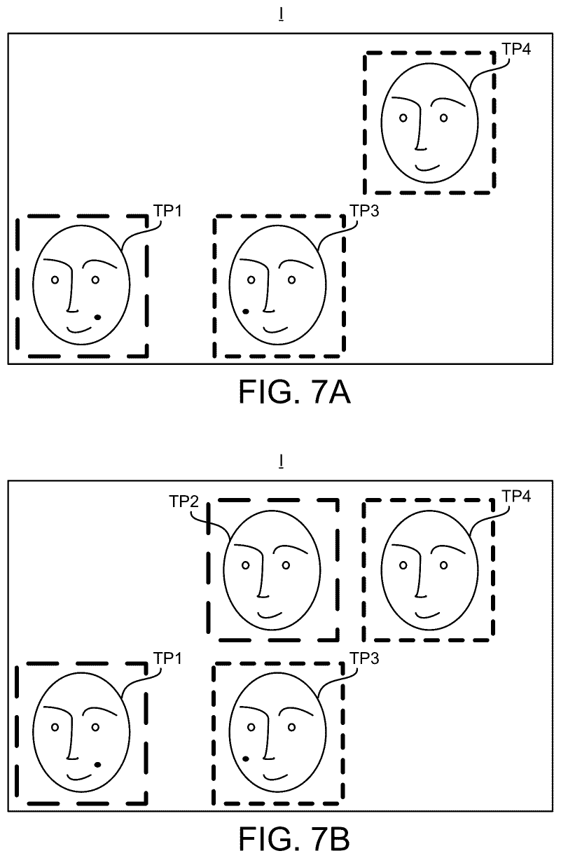

The information processing apparatus 2 is configured as an apparatus for sequentially authenticating the target moving in a moving direction and sequentially controlling entry of the target into the restricted area. Referring to FIG. 5 to FIG. 7B, the information processing method executed by the information processing apparatus 2 is explained. FIG. 5 is a flowchart showing the flow of the information processing method executed by the information processing apparatus 2. FIG. 6A to FIG. 7B are overview diagrams showing an overview of the information processing method executed by the information processing apparatus 2.

As shown in FIG. 5, the image acquisition part 213 acquires an image from the camera 27 (step S21). The camera 27 may be provided so as to be able to capture an image of the lane L from the position where the first camera 281 and the second camera 282 are provided to a predetermined position behind in the moving direction (this area is referred to as the “tracking area”). In this case, the image acquisition part 213 may be said to acquire an image of the tracking area. The camera 27 may be provided at a height of 2.5 meters, for example. In case the camera 27 is provided at a position higher than the average human height, the image captured by the camera 27 is likely to include a head area and an upper body area of the target. The head area and the upper body area may be suitable areas for tracking the target. In addition, in case there are a plurality of the camera 27, the image acquisition part 213 may acquire images from the plurality of the camera 27.

FIG. 6A illustrates an example of image I acquired from the camera 27. FIG. 6A illustrates an example of a case where there are four targets in the tracking area. The tracking part 211 tracks each of the targets included in the image. The tracking part 211 tracks each of the targets in the tracking area based on the image. In the case of the example in FIG. 6A, the tracking part 211 may track each of a first target TP1, a second target TP2, a third target TP3, and a fourth target TP4. Each of “TP1”, “TP2”, “TP3”, and “TP4” may be an example of identification information of the targets tracked (called “tracking ID”).

The image used for tracking by the tracking part 211 may be a single frame of a video. In this case, the image acquisition part 213 may sequentially acquire multiple frames that make up the video as images. The tracking part 211 may perform tracking by matching a same target between a past frame and a current frame. For example, the tracking part 211 may perform tracking by determining the position of the head area in the image. The tracking part 211 may match the same target in different frames based on the position of the head area in the image. The tracking part 211 may, for example, track by determining the identity of the image pattern of the head area. The tracking part 211 may also track by determining the similarity of the feature information extracted from the image of the head area.

In case there are the plurality of the camera 27, the tracking part 211 may track each of the targets included in each of the multiple images captured by the plurality of the camera 27. For example, the tracking part 211 may integrate the target included in each of the multiple images by extracting and matching feature parts of the target. The feature parts of the target may correspond to, for example, the head area of the target, the upper body area of the target, or the clothing worn by the target. The feature parts of the target may be parts that can distinguish between individuals. The feature parts of the target may not be parts that can identify individuals.

The tracking part 211 acquires association information indicating an association a group with the target included in the group (step S22). The tracking part 211 may acquire group information as the association information indicating the target is included in the first group. In addition, the tracking part 211 may acquire the group information as the association information indicating the target is included in a group that is different from the first group (e.g., the second group).

For example, the target included in the group may carry an apparatus that can output signals associating to the group information in case of moving within the lane L. The tracking part 211 may detect a location of the target included in the first group and a location of the target included in the group different from the first group (e.g., the second group) based on a location of the output of the signals associating to the group information.

The tracking part 211 associates a tracking target with a group that includes the tracking target (step S23). The tracking part 211 may associate the tracking ID with information for distinguishing the group. For example, suppose that the first group includes the first target and the second target, and the second group includes the third target and the fourth target. In this case, the tracking part 211 may associate the tracking target with the group that includes the tracking target, by adding information that can distinguish the first target TP1 and the second target TP2 being included in the same group, and information that can distinguish the third target TP3 and the fourth target TP4 being included in the same group, as shown in FIG. 6B, for example.

The determination part 216 may identify two targets from targets in the image. The determination part 216 may identify two targets located in the foreground in the image, among the targets for which it has not been determined whether they will be imaged in the first camera 281 or the second camera 282.

Of the four targets illustrated in FIG. 6A and FIG. 6B, it is assumed that it has not been determined whether the first target TP1, the second target TP2, the third target TP3, and the fourth target TP4 will be imaged by the first camera 281 or the second camera 282. In this case, the determination part 216 may identify the two targets (i.e., the first target TP1 and the second target TP2) that are in the foreground in image I. In case there are less than two targets that have not yet been determined to be captured by either the first camera 281 or the second camera 282, the determination part 215 may specify less than two targets.

The determination part 216 may determine one of the two targets to be the target to be imaged by the first camera 281, and other of the two targets to be the target to be imaged by the second camera 282, based on the image. The determination part 216 may determine the target to be imaged by the first camera 281 and the target to be imaged by the second camera 282 based on at least one of a positional relationship between the first target and the second target included in the image and a distance from each of the first target and the second target to the camera 27. In the case of the examples shown in FIG. 6A and FIG. 6B, the determination part 216 may determine that the first target TP1, which is located on the left side of image I, is the first target whose iris is imaged by the first camera 281, and that the second target TP2, which is located on the right side of image I, is the second target whose iris is imaged by the second camera 282. Alternatively, the determination part 216 may divide the image along a vertical line and determine that the first camera 281 will capture one target included in one of divided images, and that the second camera 282 will capture other target included in other of the divided images. The determination part 216 may divide the image vertically into two images, so that one image includes the one target and other image includes the other target.

In case the image includes one target, the determination part 216 may divide the image into left image and right image at the center, and determine that the first camera 281 will capture the target in case the target is included in the left image, and that the second camera 282 will capture the target in case the target is included in the right image.

The determination part 216 may emit directional light to the first target TP1 from a position adjacent to the first camera 281, and may emit directional light to the second target TP2 from a position adjacent to the second camera 282. For example, the determination part 216 may emit directional light to the first target TP1 from a position adjacent to the first camera 281 using a laser pointer, and may emit directional light to the second target TP2 from a position adjacent to the second camera 282 using a laser pointer. In addition, the determination part 216 may display information indicating the first target TP1 at a position adjacent to the first camera 281, and may display information indicating the second target TP2 at a position adjacent to the second camera 282.

In addition, in case the tracking part 211 detects at least one of the targets that are in the same position for a predetermined period of time or more and that is of the same size for a predetermined period of time or more in the image, the tracking part 211 may determine that the corresponding target is standing still. The information processing apparatus 2 may have a mechanism that outputs information to the relevant targets to alert them that they are standing still, and may output information to alert them that they are standing still. In addition, the camera 27 may be set at a height where the target cannot look into the camera lens, and this may be used to suppress the target from standing still.

The first camera 281 may capture an image of the iris of the first target TP1 and acquire iris image 1, which includes the iris of the first target TP1. In addition, the second camera 282 may capture the iris of the second target TP2 and acquire iris image 2, which includes the iris of the second target TP2. The authentication part 214 acquires the iris image 1 from the first camera 281 and the iris image 2 from the second camera 282 as the biometric information. The authentication part 214 performs authentication using the iris image 1 and authentication using the iris image 2.

The authentication part 214 authenticates the target by matching an iris image as the biological information of the target with registered information. The authentication part 214 may calculate a matching score by matching the iris image with a previously registered iris image. The matching score may refer to a value indicating the degree of match between the acquired iris image and the previously registered iris image. The matching score may also refer to a value indicating the degree of match between features extracted from the acquired iris image and previously registered features. Therefore, the authentication part 214 may calculate the matching score by matching the features extracted from the acquired iris image and the previously registered features.

The authentication part 214 determines whether iris authentication has been successful. In iris authentication, in case the matching score is greater than or equal to a predetermined threshold value, it is determined that the target is a person who has been registered in advance. The authentication part 214 may determine that iris authentication has been successful in case the matching score exceeds the predetermined threshold value. In this case, the authentication part 214 may determine that iris authentication is unsuccessful in case the matching score is less than the predetermined threshold value. In addition, in case the matching score is equal to the predetermined threshold value, it may be determined that the biometric authentication is successful or that biometric authentication is unsuccessful.

In addition, the authentication part 214 may perform face authentication using a face image in addition to the iris authentication. The authentication part 214 may perform face authentication by matching the face image of the target included in the image captured by the camera 27 with a face image of the target that has been registered in advance. In other words, the authentication part 214 may perform multimodal authentication.

In this embodiment, the first target may be the target that arrives at the endpoint E first in the group. The target that arrives at the endpoint E may be a target that has been authenticated. The target that has been authenticated may be a target that has been determined to be successful or unsuccessful in authentication. Alternatively, the target that arrives at the endpoint E may be said to have been authenticated. For example, a target that has been successfully authenticated before arriving at the endpoint E may be a target that has been successfully authenticated. Also, a target that has not been successfully authenticated before arriving at the endpoint E may be a target that has unsuccessfully authenticated. Note that in FIG. 6A and FIG. 6B, the second target TP2 is illustrated as a target that moves on the right side of the drawing, but in case a target that moves on the right side of the drawing arrives at the endpoint E before a target that moves on the left side of the drawing, the target that moves on the right side of the drawing may be referred to as the first target. The determination of step S24 is repeated until the first target arrives at the end point E.

In case the first target arrives at the endpoint E (Step S24: other than “No”) and the authentication of the first target is successful (Step S24: authentication is successful), the control part 212 does not restrict the first target from entering the restricted area (Step S25). On the other hand, in case the authentication of the first target is complete (step S24: other than “No”) and the authentication of the first target is unsuccessful (step S24: authentication is unsuccessful), the control part 212 restricts the entry of the first target into the restricted area.

The control part 212 determines whether a target different from the first target is included in the first group (i.e., the group that includes the first target) (step S26). The control part 212 may also determine whether the target moving alongside the first target is included in the first group (i.e., the group that includes the first target). Alongside the first target may mean lining up in a direction different from a moving direction of the first target, and may mean lining up in the width direction of the lane L. For example, the control part 212 may determine whether the target moving alongside the first target that has arrived the endpoint E of the lane L is included in the first group.

For example, in the cases shown in FIG. 6A and FIG. 6B, the second target TP2, which moves alongside the first target TP1, is included in the first group (Step S26: Yes). In this case, the control part 212 restricts the entry of the first target TP1 and the second target TP2 into the restricted area (Step S27).

FIG. 7A shows an example of the case where the first target TP1 and the third target TP3, which is the target that is different from the first target TP1, move. In other words, FIG. 7A may also show an example of the case where the first target TP1 and the third target TP3 move side by side. The third target TP3 is included in the second group and not included in the first group (Step S26: No). In this case, the control part 212 does not restrict the entry of the third target TP3 into the restricted area, but only restricts the entry of the first target TP1 into the restricted area (Step S28). As shown in FIG. 7B, in case the second target TP2, which is included in the first group and is located behind the first target TP1, moves, the control part 212 may restrict the entry of the second target TP2 into the restricted area in case the second target TP2 arrives the endpoint E of the lane L.

A display apparatus may be provided at the endpoint E of the lane L. In this case, the control part 212 may notify the target of the success or unsuccess of the authentication of the target by displaying information indicating the success or unsuccess of the authentication of the target on the display apparatus, and may control the entry of the target into the restricted area.

The control part 212 may display on the display apparatus the action that the target should take depending on the success or unsuccess of the authentication. For example, the action that the target should take in case the authentication is successful may be entry to the restricted area. For example, the action that the target should take in case the authentication is unsuccessful may be to re-enter the lane L. For example, the action that the target should take in case the authentication is unsuccessful may be to undergo an examination by an examiner who will judge whether or not to admit the target to the restricted area.

For example, a gate may be provided at the endpoint E of the lane L. For example, a flap that can be opened and closed may be provided at the endpoint E of the lane L. In case the authentication of the target is successful, the control part 212 may open the closed gate to allow the target to enter the restricted area. In case the authentication of the target is unsuccessful, the control part 212 may close the open gate to restrict the entry of the target into the restricted area. For example, the control part 212 may notify the target of the success or unsuccess of the authentication by illuminating feet of the target in a different color depending on the success or unsuccess of the authentication, and may control the entry of the target into the restricted area.

A security guard may be stationed at the endpoint E of the lane L. The security guard may approach target who does not take the action in accordance with the authentication result notified by the control part 212.

In addition, the authentication of the target may be performed by an other system other than the information processing system S. In this case, the authentication part 214 may transmit the biometric information to the other system and receive the authentication results from the other system.

### 2-3: Technical Effect

The information processing apparatus 2 according to this disclosure can differ the control for each of the targets included in different groups in case the targets included in different groups are moving side by side. This allows many targets to be moved into the restricted area in a short time without preventing the targets included in different groups from moving side by side.

### 3: Third Example Embodiment

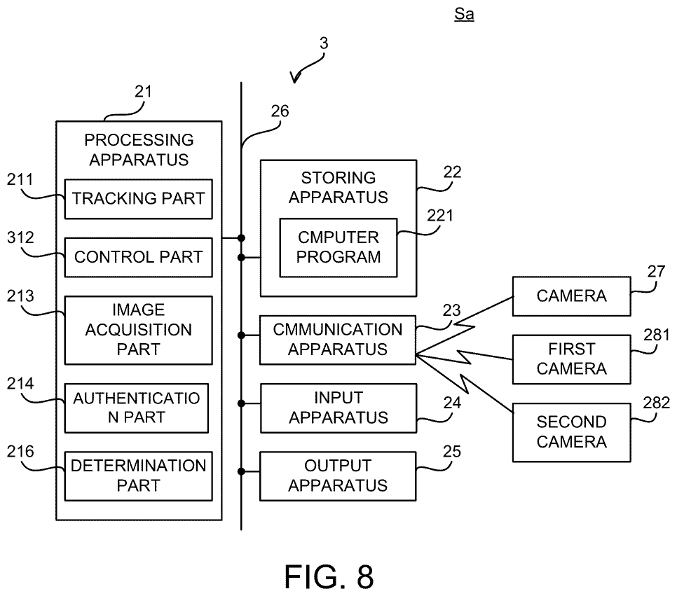

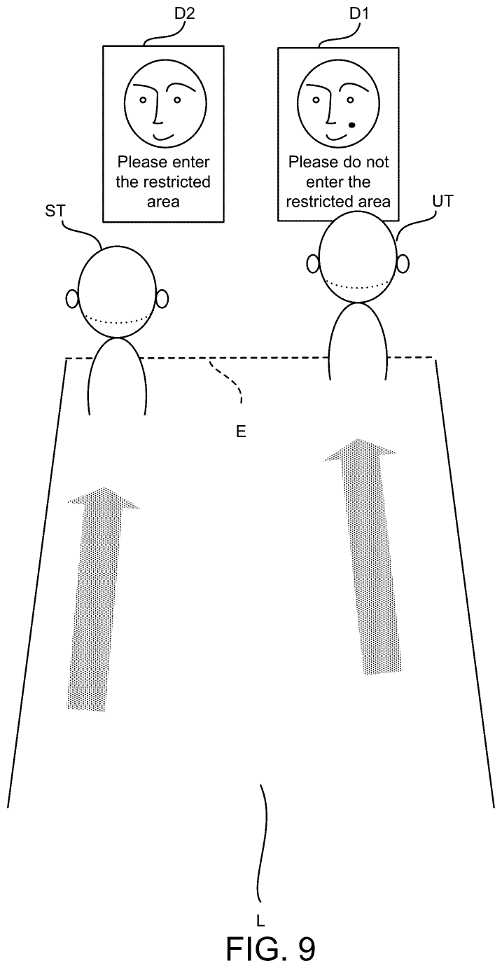

The third embodiment of the information processing apparatus, the information processing system, the information processing method, and the recording medium is explained with reference to FIG. 8 to FIG. 12. The third embodiment of the information processing apparatus, the information processing system, the information processing method, and the recording medium is explained using an information processing system Sa, including an information processing apparatus 3 according to this disclosure. In the third embodiment, explanations that overlap with the explanations of the first and second embodiments given above are omitted as appropriate. In addition, on the drawings, the parts that are common with the second embodiment are indicated with the same reference numerals.

As shown in FIG. 8, the information processing system Sa includes the information processing apparatus 3, the camera 27, the first camera 281, and the second camera 282. The information processing apparatus 3 may communicate with the camera 27, the first camera 281, and the second camera 282 via the communication apparatus 23. As shown in FIG. 8, the processing apparatus 21 provided by the information processing apparatus 3 may have the tracking part 211, a control part 312, the image acquisition part 213, the authentication part 214, and the determination part 216 as function blocks that are logically realized or as processing circuits that are physically realized.

The information processing apparatus 3 is configured as an apparatus for sequentially authenticating the targets moving in a moving direction and sequentially controlling the entry of the target into the restricted area. Referring to FIG. 9 to FIG. 12, the information processing method executed by the information processing apparatus 3 is explained. FIG. 9 to FIG. 12 are overview diagrams showing an overview of the information processing method executed by the information processing apparatus 3.

### Control Example 1

The control part 312 may display information regarding the entry of one target moving on one side of the width of the lane L into the restricted area on the one side of the width of the lane L near the endpoint E of the lane L, and may control the entry of the one target into the restricted area. Similarly, the control part 312 may display information regarding the entry of other target moving on other side of the width of the lane L into the restricted area on the other side of the width of the lane L near the endpoint E of the lane L, and may control the entry of the other target into the restricted area. As shown in FIG. 9, for example, a first display apparatus D1 may be provided at the one side of the width direction near the endpoint E of the lane L, and a second display apparatus D2 may be provided at the other side of the width direction near the end point E of the lane L.

In case the one target is a target UT that has unsuccessfully authenticated, the control part 312 may control the first display apparatus D1 to display information notifying the entry into the restricted area is restricted, such as “Please do not enter the restricted area”. The control part 312 may display the information of a notification together with a face image of the one target UT to make it easier to understand that the notification is intended for the one target UT. The information notifying the entry into the restricted area is restricted may be information notifying the specific action to be taken by the one target. For example, in case the same authentication is to be performed again in the lane L, the information such as “Please go back and walk down the lane again” may be notified. Also, in case the authentication is to be performed again in a place other than the lane L (referred to as the “re-authentication area”), the information such as “Please move to the re-authentication area” may be notified. In the re-authentication area, for example, authentication by an examiner may be performed. The re-authentication may be other than iris authentication, for example, fingerprint authentication and/or passport verification.

In case the same authentication is to be performed again in the lane L, the control part 312 may instruct the target to change the location within the lane L. For example, in case the target moves on the one side of the width of the lane L and has unsuccessfully authenticated, the control part 312 may instruct the target to move on the other side of the width of the lane L. Also, in case both the first target that has moved on the one side of the width of the lane L and the second target that has moved on the other side of the width of the lane L have unsuccessfully authenticated, the control part 312 may instruct the first target to move on the other side of the width of the lane L and may instruct the second target to move on the one side of the width of the lane L.

In case authentication is unsuccessful repeatedly in the same location, for example, in case authentication is unsuccessful certain number of times or more, a worker may be called to perform maintenance on the information processing system, etc.

In case the other target is the other target ST that has successfully authenticated, the control part 312 may control the second display apparatus D2 to display information notifying the entry into the restricted area is not restricted, such as “Please enter the restricted area”. The control part 312 may display the information of a notification together with a face image of the other target ST in make it easier to understand that the notification is intended for the other target ST.

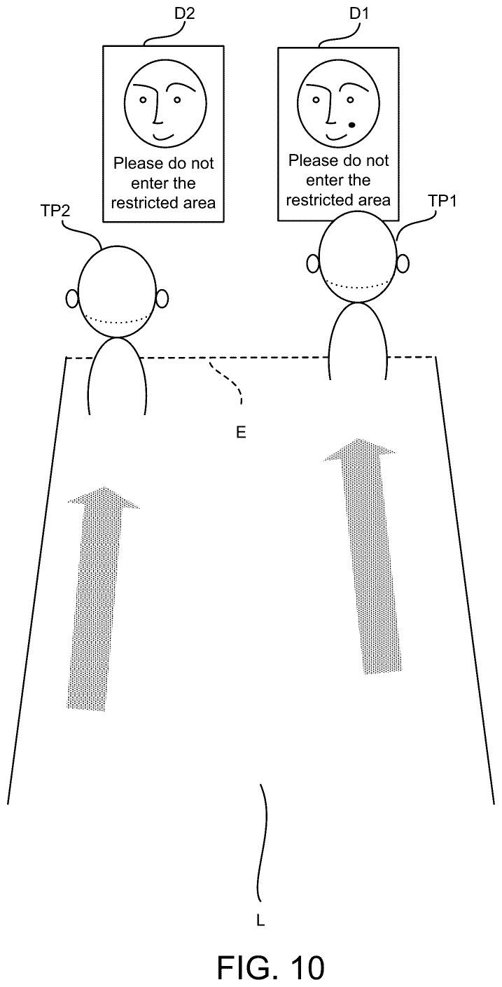

FIG. 10 shows an example where the first target TP1 and the second target TP2 are included in the first group and the first target TP1 has unsuccessfully authenticated. As shown in FIG. 10, the control part 312 may control the first display apparatus D1 to display information notifying entry into the restricted area is restricted, such as “Please do not enter the restricted area”.

In addition, the control part 312 may control the second display apparatus D2 to display information notifying the entry into the restricted area is restricted, such as “Please do not enter the restricted area”.

### Control Example 2

At the endpoint E of the lane L, there may be two pairs of gates that can be opened and closed. In this case, the control part 312 may control the opening and closing of each of the two pairs of gates to control entry into the restricted area. The control part 312 may control each of the two pairs of gates to operate independently. In other words, the control part 312 may control one gate to open while controlling the other gate to close.

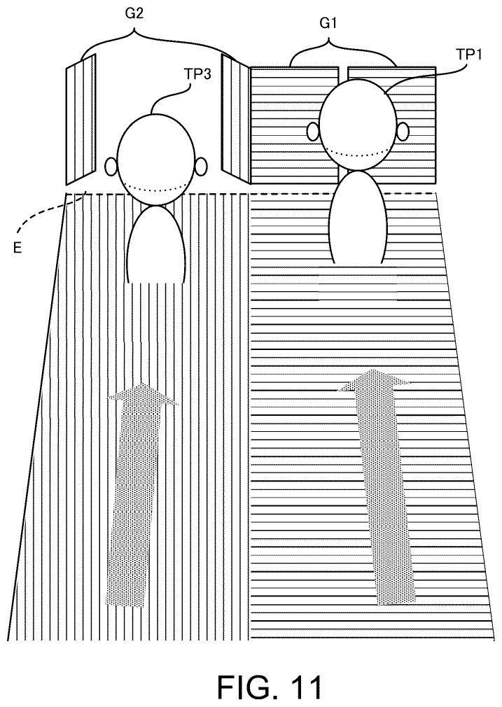

As shown in FIG. 11, the one side and the other side of the horizontal direction perpendicular to the moving direction in the space in which the first target TP1 and the second target TP2 can move side by side may have different appearance. For example, the right side of the floor surface of the lane L as seen from the target and the right gate G1 may be given the same color, and the left side of the floor surface of the lane L as seen from the target and the left gate G2 may be given the same color. For example, the right side of the floor surface of the lane L as seen from the target and the right-hand gate G1 may be colored blue, and the left side of the floor surface of the lane L as seen from the target and the left-hand gate G2 may be colored green. For example, the right side of the floor surface of the lane L as seen from the target and the right-hand gate G1 may be given the first pattern, and the left side of the floor surface of the lane L and the left-hand gate G2 may be given the second pattern.

FIG. 11 shows an example in which the first target TP1 and the third target TP3 are included in different groups, and the first target TP1 has unsuccessfully authenticated. As shown in FIG. 11, the control part 312 may control the gate G1 facing the first target TP1 to be closed, restricting the first target TP1 from entering the restricted area. The control part 312 may also control to open the gate G2 facing the third target TP3, which is included in a different group from the first target TP1, and allow the third target TP3 to enter the restricted area.

### Control Example 3

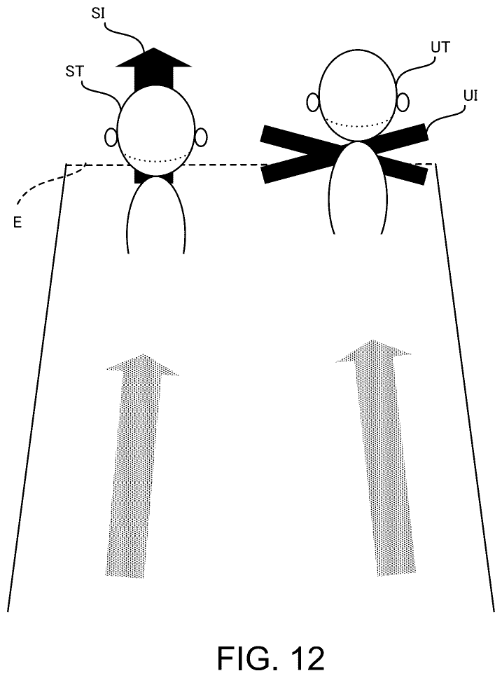

The control part 312 may project different images to the feet of the target depending on whether the authentication is successful or unsuccessful. As shown in FIG. 12, in case the one target is the target UT that has unsuccessfully authenticated, the control part 312 may project the image UI, which indicates that entry into the restricted area is restricted, onto the feet of the target UT. In case the other target is the target ST that has successfully authenticated, the control part 312 may project the image SI, which indicates that entry into the restricted area is permitted, onto the feet of the target ST. Alternatively, the control part 312 may emit sound with directionality toward the target depending on whether or not the authentication is successful.

The control part 312 may implement at least one of the above-described control examples 1, 2, and 3. In other words, the control part 312 may implement a combination of two or more of the above-described control examples 1, 2, and 3.

### 4: Fourth Example Embodiment

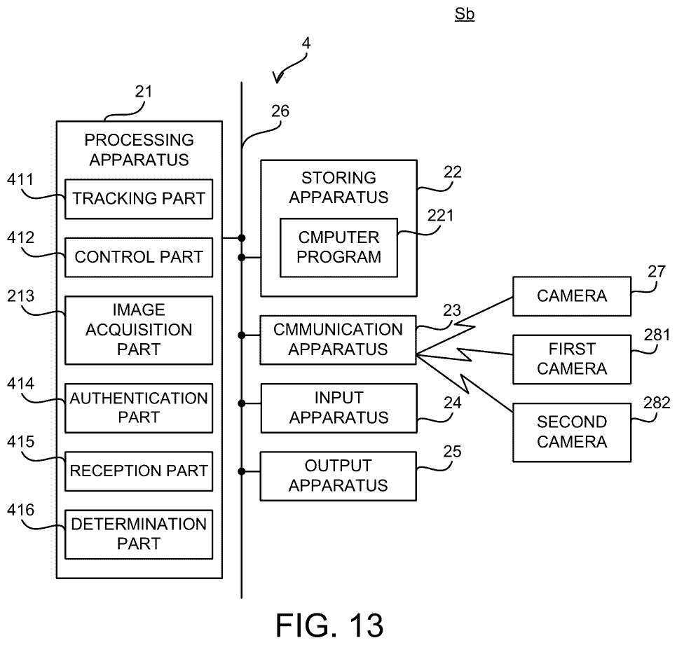

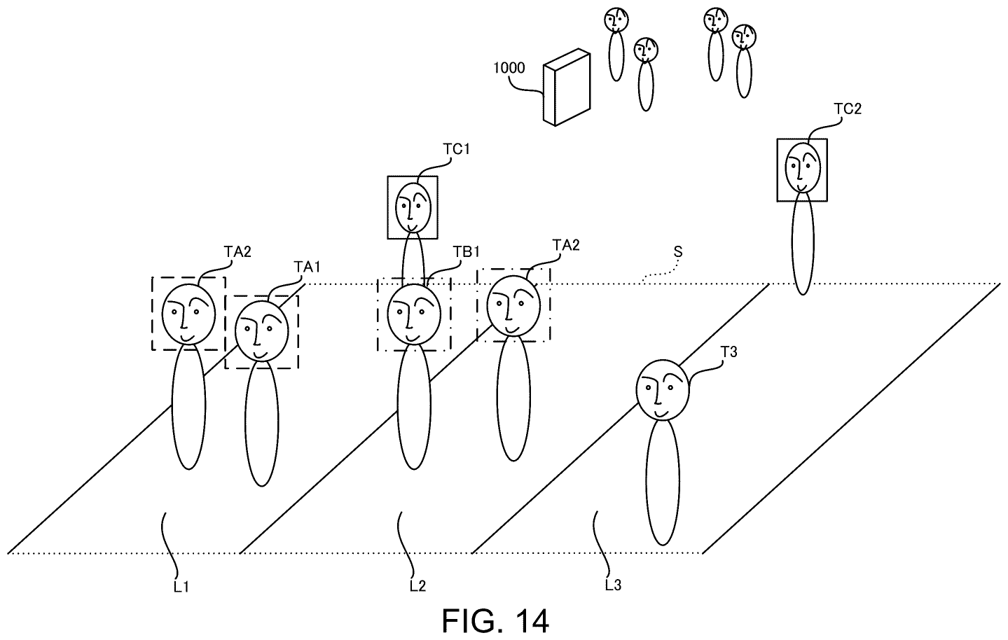

The fourth embodiment of the information processing apparatus, the information processing system, the information processing method, and the recording medium is explained with reference to FIG. 13 and FIG. 14. The fourth embodiment of the information processing apparatus, the information processing system, the information processing method, and the recording medium is explained below using an information processing system Sb, including the information processing apparatus 4 according to this disclosure. For the fourth embodiment, explanations that overlap with the explanations of the first to third embodiments given above are omitted as appropriate. In addition, on the drawings, the parts that are common to the first and third embodiments are indicated with the same reference numerals.

### 4-1 Configuration of the Information Processing System Sb

As shown in FIG. 13, the information processing system Sb includes an information processing apparatus 4, the camera 27, the first camera 281, and the second camera 282. The information processing apparatus 4 may communicate with the camera 27, the first camera 281, and the second camera 282 via the communication apparatus 23. As shown in FIG. 13, the processing apparatus 21 provided by the information processing apparatus 4 may have a reception part 415, in addition to a tracking part 411, a control part 412, the image acquisition part 213, an authentication part 414, and a determination part 416, as a function block that is logically realized or as a processing circuit that is physically realized.

The reception part 415 receives an input of the association information indicating an association a group with the target included in the group. The reception part 415 may receive the group information as the association information indicating the target is included in the group. The reception part 415 may receive the association information that associates information for distinguishing the group with distinguishing information for distinguishing the target.

### 4-2: Application Examples of Information Processing System Sb

The information processing system Sb according to this embodiment may be applied to a location where multiple lanes L are provided adjacent to each other in the width direction of the lanes L. FIG. 14 illustrates an example where lanes L1, L2, and L3 are provided adjacent to each other in the width direction.

In this embodiment, the camera 27 may be provided to be able to capture images of multiple lanes L. For example, the image acquisition part 213 may be capable of acquiring an image such as that illustrated in FIG. 14 from the camera 27.

The tracking part 411 may track each of the tracking targets moving in any of the multiple lanes L, while associating each of the tracking targets with the group that includes the tracking targets. Although it is omitted from the illustration, the first camera 281 and the second camera 282 may be provided for each lane L. The tracking part 411 may determine which of the first camera 281 and the second camera 282 is to be used for each lane L. In addition, the operation of the control part 412, the authentication part 414, and the determination part 416 may be independent for each lane L.

FIG. 14 illustrates a case where a target TA1 and a target TA2 moving in a lane L1 are included in a group A, a target TB1 and a target TB2 moving in a lane L2 are included in a group B, a target TC1 moving in the lane L1 and a target TC2 moving in a lane L3 are included in a group C, and a target T3 moving in the lane L3 is not included in any group (i.e., the target T3 is moving alone in the lane L).

In other words, each of the targets included in the same group, such as the target TC1 and the target TC2, may move on different lanes L. For example, even if the targets are included in the same group, they may move in different lanes L where there are relatively few people moving. The targets included in the same group may be instructed by an attendant to move in different lanes L. The tracking part 411 can track each of the tracking targets that are included in the same group but move in different lanes L while associating them with the same group. The control part 412 can, for example, restrict the entry of target TC2 into the restricted area in case the target TC1 has unsuccessfully authenticated.

### 4-3: Example of Reception Operation

As shown in FIG. 14, for example, an information input apparatus 1000 is provided behind the start point S of the lane L in the moving direction, and the targets who want to be managed in group units may input the association information to the information input apparatus 1000. In this case, the reception part 415 may receive the association information input to the information input apparatus 1000.

For example, the target may input distinguishing information for distinguishing from the target by having a reader included in the information input apparatus 1000 read a signal output by an apparatus held by the target. Alternatively, the signals output by apparatuses held by targets included in the same group may be the same signal. In other words, the association information received by the reception part 415 may be information that cannot distinguish the targets.

For example, the information input apparatus 1000 may present an overhead image of an area around the information input apparatus 1000 to the targets. The overhead image of the area around the information input apparatus 1000 may include the targets that the targets want to manage in the group. The targets may input the association information indicating the association the group with the targets included in the group by selecting the targets included in the group included in the overhead image of the area around the information input apparatus 1000. The information input apparatus 1000 may generate the association information that associates, for example, information distinguishing the group with an upper body feature information of the target as the distinguishing information for distinguishing the target. Alternatively, the association information indicating the association the group with the targets included in the group may be received by submitting it to an attendant waiting behind the start point S of the lane L in the moving direction.

The reception part 415 may receive association information other than the association information input to the information input apparatus 1000. For example, the reception part 415 may receive the association information via the Internet. For example, the reception part 415 may receive the association information input by the target using a portable apparatus. Furthermore, the reception operation of the association information may be linked to an airplane check-in operation.

### 4-4: Technical Effects

The information processing apparatus 4 according to this disclosure can track each of the tracking targets that are included in the same group but move in different lanes L, while associating them with the same group. In addition, the information processing apparatus 4 can restrict the entry of the targets into the restricted area even if the targets included in the same group that move in different lanes L have unsuccessfully authenticated, and can prevent the targets included in the group from losing sight of each other and being unable to act together.

### 5: Fifth Example Embodiment

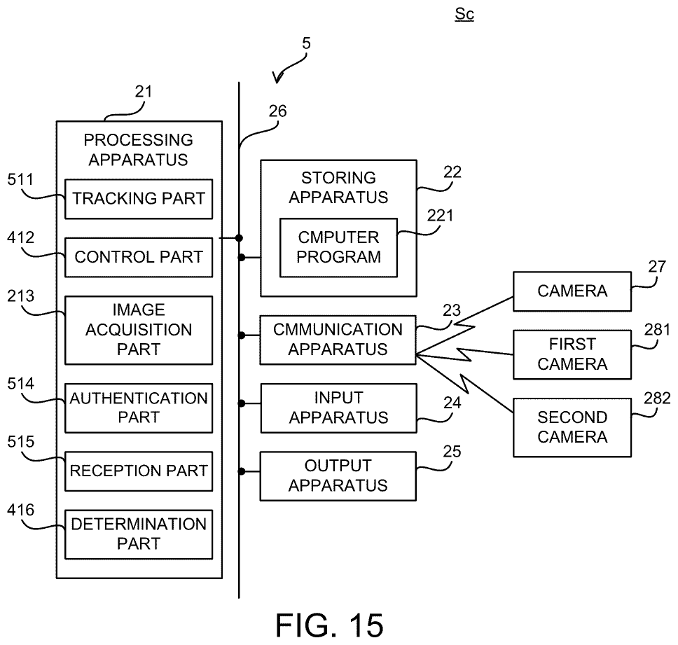

The fifth embodiment of the information processing apparatus, the information processing system, the information processing method, and the recording medium is explained with reference to FIG. 15. The fifth embodiment of the information processing apparatus, the information processing system, the information processing method, and the recording medium is explained below using an information processing system Sc, which includes an information processing apparatus 5 according to this disclosure. In the drawings, the same reference numerals are used to indicate the parts that are common to the first to fourth embodiments.

As shown in FIG. 15, the information processing system Sc includes the information processing apparatus 5, the camera 27, the first camera 281, and the second camera 282. The information processing apparatus 5 may communicate with the camera 27, the first camera 281, and the second camera 282 via the communication apparatus 23. As shown in FIG. 15, the processing apparatus 21 provided by the information processing apparatus 5 may have the tracking part 411, the control part 412, the image acquisition part 213, an authentication part 514, a reception part 515, and the determination part 416 as function blocks that are logically realized or processing circuits that are physically realized.

The reception part 515 may receive identification information that can identify the target as the distinguishing information that distinguish the target. Examples of the identification information that can identify the target include information that can be acquired from a smartphone carried by the target, information that can be acquired from an integrated circuit mounted on a passport carried by the target, and information that can be acquired from a beacon carried by the target. In this case, the authentication part 514 can perform authentication using the identification information of the target in addition to the biometric information of the target. The identification information of the target may be identification information that can identify the registered information of the target. Therefore, the authentication part 514 can match the iris image of the target acquired from the first camera 281 or the second camera 282 with the registered information of the target. In other words, the authentication part 514 can perform 1-to-1 authentication instead of 1-to-N authentication.

### Technical Effects

Because the information processing apparatus 5 according to this disclosure can perform 1-to-1 authentication instead of 1-to-N authentication, it can perform authentication in a shorter time than in case performing 1-to-N authentication. It can also improve authentication accuracy.

### 6: Sixth Example Embodiment

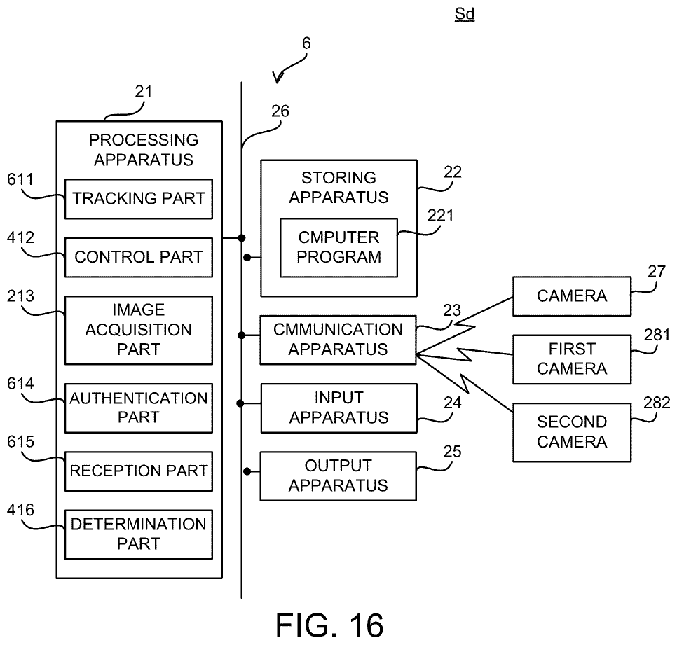

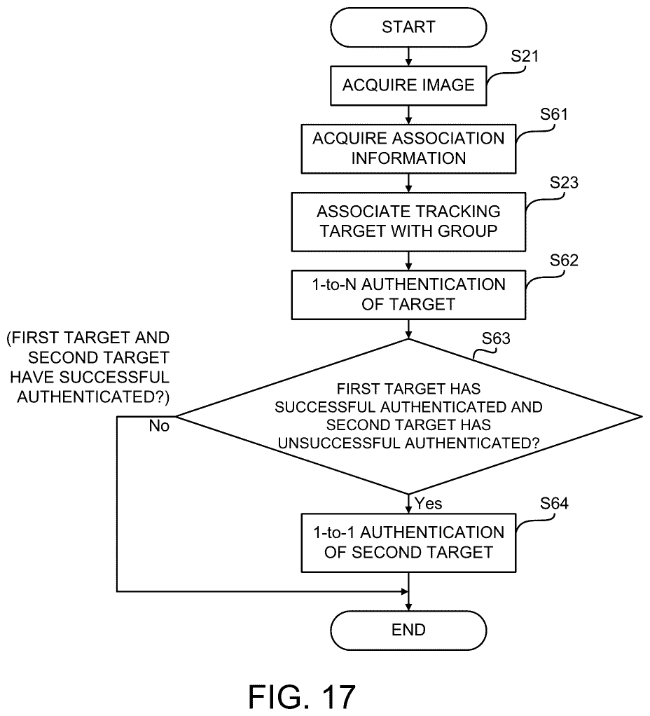

The sixth embodiment of the information processing apparatus, the information processing system, the information processing method, and the recording medium is described below with reference to FIG. 16 and FIG. 17. The sixth embodiment of the information processing apparatus, the information processing system, the information processing method, and the recording medium is described below using an information processing system Sd, which includes an information processing apparatus 6 according to this disclosure. For the sixth embodiment, the description that overlaps with the description of the first to fifth embodiments described above is omitted as appropriate. In addition, on the drawings, the parts that are common to the first to fifth embodiments are indicated with the same reference numerals.

As shown in FIG. 16, the information processing system Sd includes the information processing apparatus 6, the camera 27, the first camera 281, and the second camera 282. The information processing apparatus 6 may communicate with the camera 27, the first camera 281, and the second camera 282 via the communication apparatus 23. As shown in FIG. 16, the processing apparatus 21 provided by the information processing apparatus 6 may have a tracking part 611, the control part 412, the image acquisition part 213, an authentication part 614, a reception part 615, and the determination part 416 as function blocks that are logically realized or processing circuits that are physically realized.

As mentioned above, the reception part 615 may receive the identification information that can identify the target as the distinguishing information that distinguish the target. In this case, the authentication part 614 can authenticate the target using the identification information in addition to the biometric information of the target. The authentication part 614 can perform 1-to-N authentication or 1-to-1 authentication.

### [Information Processing Method Executed by the Information Processing Apparatus 6]

The information processing apparatus 6 is configured as an apparatus for sequentially authenticating the targets moving in the moving direction and sequentially controlling the entry of the targets into the restricted area. With reference to FIG. 17, the information processing method executed by the information processing apparatus 6 will be described. FIG. 17 is a flowchart showing the flow of the information processing method executed by the information processing apparatus 6. In the flow of the information processing method executed by the information processing apparatus 6, the authentication of the first target and the second target included in the first group will be described. In addition, in the flow of the information processing method executed by the information processing apparatus 6, the reception part 615 receives the identification information capable of identifying the targets as distinguishing information that distinguish the targets included in the first group.

As shown in FIG. 17, the image acquisition part 213 acquires an image from the camera 27 (step S21). The tracking part 611 acquires the association information that associate information that distinguishes groups with the identification information that can identify the targets (step S61). The tracking part 611 associates the tracking target with the group that includes the tracking targets (step S23). The authentication part 614 performs 1-to-N authentication of the first target and the second target included in the first group (step S62).

In case the 1-to-N authentication of the first target is successful and the 1-to-N authentication of the second target is unsuccessful (step S63: Yes), the authentication part 614 matches the biometric information of the second target with the registered information of the target included in the first group other than the first target (step S64). Note that since the case where the first target and the second target are included in the first group is described, the authentication part 614 performs 1-to-1 authentication of the second target. In case the 1-to-N authentication of the first target and the second target is successful (step S63: No), the flow of the information processing method executed by the information processing apparatus 6 ends.

### Technical Effects

The information processing apparatus 6 according to this disclosure can perform 1-to-1 authentication, so it can re-authenticate in a relatively short time after 1-to-N authentication is unsuccessful. It can also improve authentication accuracy.

### 7: Seventh Example Embodiment

The seventh embodiment relates to the information processing apparatus, the information processing system, the information processing method, and the recording medium. The information processing system of the seventh embodiment performs the information processing method described above. The information processing system of the seventh embodiment may include one or more information processing apparatuses, which are omitted from the illustration. In other embodiments, one information processing apparatus performs the information processing method described above, but in the seventh embodiment, one or more information processing apparatuses may perform the information processing method described above. In other words, each of the multiple steps included in the above-mentioned information processing method may be performed by a different information processing apparatus. For example, some of the multiple steps included in the above-mentioned information processing method may be performed by a first information processing apparatus, and the remaining steps of the multiple steps included in the above-mentioned information processing method may be performed by a second information processing apparatus.

### 8: Supplementary Notes

With regard to the above-described embodiments, the following Supplementary Notes may also be described, but are not limited to the following.

### Supplementary Note 1

An information processing apparatus including:
at least one memory configured to store instructions; and
at least one processor configured to execute the instructions to:
track a first target and a second target included in a first group; and
control to restrict the first target and the second target from entering a predetermined area in case an authentication of the first target is unsuccessful.

### Supplementary Note 2

The information processing apparatus according to Supplementary Note 1, wherein the predetermined area is an area where an entry of a target that has unsuccessful authentication is restricted,
in case the authentication of the first target is unsuccessful and a third target, who is a target different from the first target and is not included in the first group, the at least one processor configured to execute the instructions to:
   restrict the entry of the first target to the predetermined area; and
   does not restrict the entry of the third target to the predetermined area.

### Supplementary Note 3

The information processing apparatus according to Supplementary Note 1, wherein
the at least one processor configured to execute the instructions to
   control an entry of a target into the predetermined area from a passage having a width allowing movements of two targets aligned in a direction different from a moving direction, wherein the passage is one of a plurality of passages provided.

### Supplementary Note 4

The information processing apparatus according to Supplementary Note 1, wherein
the at least one processor configured to execute the instructions to
   receive an input of association information indicating an association between a group and a target included in the group
   track the first target and the second target included in the first group based on the association information.

### Supplementary Note 5

The information processing apparatus according to Supplementary Note 4, wherein
the at least one processor configured to execute the instructions to
   receive the association information that associates information for distinguishing the group with distinguishing information for distinguishing the target.

### Supplementary Note 6

The information processing apparatus according to Supplementary Note 5, wherein
the at least one processor configured to execute the instructions to
   authenticate the target by matching biometric information of the target with registered information; and
   in case the distinguishing information is identification information that be able to identify the target, match the biometric information of the target with the registered information corresponding to the identification information.

### Supplementary Note 7

The information processing apparatus according to Supplementary Note 5, wherein
the at least one processor configured to execute the instructions to
   authenticate the target by matching biometric information of the target with registered information; and
   in case the distinguishing information is identification information that be able to identify the target and case the authentication of the first target is successful but the authentication of the second target is unsuccessful, match biometric information of the second target with the registered information of a target included in the first group other than the first target.

### Supplementary Note 8

An information processing method including:
tracking a first target and a second target included in a first group; and
controlling to restrict the first target and the second target from entering a predetermined area in case of an authentication of the first target is unsuccessful.

### Supplementary Note 9

A non-transitory recording medium on which a computer program that allows a computer to execute the information processing method according to claim 8 is recorded.

This disclosure can be changed as appropriate within the scope that does not contradict the gist or idea of the invention that can be read from the claims and the entire specification, and the information processing apparatus, the information processing systems, the information processing methods, and the recording media that involve such changes are also included in the technical concept of this disclosure.

### DESCRIPTION OF REFERENCE NUMERALS

1,2,3,4,5,6 information processing apparatus
11, 211, 411, 611 tracking part
12, 212, 312, 412 control part
S, Sa, Sb, Sc, Sd information processing system
213 image acquisition part
214, 414, 514, 614 authentication part
216, 416 determination part
27 camera
281 first camera
282 second camera
415, 515, 615 reception part

What is claimed is:

1. An information processing apparatus comprising:
at least one memory configured to store instructions; and
at least one processor configured to execute the instructions to:
track a first target and a second target included in a first group; and
control to restrict the first target and the second target from entering a predetermined area in case an authentication of the first target is unsuccessful.

2. The information processing apparatus according to claim 1, wherein the predetermined area is an area where an entry of a target that has unsuccessful authentication is restricted,
in case the authentication of the first target is unsuccessful and a third target, who is a target different from the first target and is not included in the first group, the at least one processor configured to execute the instructions to:
restrict the entry of the first target to the predetermined area; and
does not restrict the entry of the third target to the predetermined area.

3. The information processing apparatus according to claim 1, wherein
the at least one processor configured to execute the instructions to
control an entry of a target into the predetermined area from a passage having a width allowing movements of two targets aligned in a direction different from a moving direction, wherein the passage is one of a plurality of passages provided.

4. The information processing apparatus according to claim 1, wherein
the at least one processor configured to execute the instructions to
receive an input of association information indicating an association between a group and a target included in the group
track the first target and the second target included in the first group based on the association information.

5. The information processing apparatus according to claim 4, wherein
the at least one processor configured to execute the instructions to
receive the association information that associates information for distinguishing the group with distinguishing information for distinguishing the target.

6. The information processing apparatus according to claim 5, wherein
the at least one processor configured to execute the instructions to
authenticate the target by matching biometric information of the target with registered information; and
in case the distinguishing information is identification information that be able to identify the target, match the biometric information of the target with the registered information corresponding to the identification information.

7. The information processing apparatus according to claim 5, wherein
the at least one processor configured to execute the instructions to
authenticate the target by matching biometric information of the target with registered information; and
in case the distinguishing information is identification information that be able to identify the target and case the authentication of the first target is successful but the authentication of the second target is unsuccessful, match biometric information of the second target with the registered information of a target included in the first group other than the first target.

8. An information processing method comprising:
tracking a first target and a second target included in a first group; and
controlling to restrict the first target and the second target from entering a predetermined area in case of an authentication of the first target is unsuccessful.

9. A non-transitory recording medium on which a computer program that allows a computer to execute the information processing method according to claim 8 is recorded.
